(19) United States
(12) Patent Application Publication
(10) Pub. No.: US 2011/0315568 A1
(43) Pub. Date: Dec. 29, 2011

(54) DEVICE FOR ORGANIZING THE ADMINISTRATION OF PILLS AT PREDETERMINED TIME INTERVALS

(76) Inventors: Puig Josep, Barcelona (ES); Ribot Nuria, Barcelona (ES)

(21) Appl. No.: 13/147,136

(22) PCT Filed: Jan. 29, 2010
(86) PCT No.: PCT/CN2010/000130

§ 371 Date: Sep. 14, 2011

(30) Foreign Application Priority Data
Jan. 29, 2009 (ES) ES 1069601

(51) Int. Cl. A61J 1/03; A45F 5/00

(52) U.S. Cl. 206/38

(57) ABSTRACT

A device for organizing the administration of pills at predetermined time intervals, characterized in that it has a main body (2) used as an individual tissue ring with an opening (3), through which tissues can be inserted, and that the main body (2) includes at least one compartment (4,4′,4″), which can hold at least one pill, covered by at least one lid (5,5′,5″).

### BACKGROUND OF THE INVENTION

1. Field of the Invention

The invention refers to a device for organizing the administration of pills at predetermined time intervals.

2. Description of the Related Art

There are a large number of people in the population who have chronic diseases, such as Parkinson's disease, hypertension and hypercholesterolemia. These people must take medication on a regular basis, in other words, at predetermined and repetitive intervals, for example, every eight or twelve hours. Furthermore, in some cases, the medication consists of a cocktail of not only one, but several pills with different respective administration intervals. This obligates the patient to be very disciplined in order to avoid taking the wrong pill at the wrong time. Obviously, this organizational discipline is not easy to maintain and it is relatively easy for errors to occur when taking the pills or for the patient to forget to take them. This is especially true in the case of elderly patients.

In order to try to solve this problem, pillboxes relying on the technique referred to as PDS (Personalized Dosage System) are used. Such a pillbox consists of a small box with one or more compartments sealable by a lid that allows the patient to organize the respective medication by day, week, etc. At the beginning of the day or week, for example, the patient or the person in charge of administering the medication places all the pills that must be taken at each specific time of day inside the pillbox. Therefore, when the time comes to take the medication, the patient need not worry about which pills to take. He simply opens the lid corresponding to the day of the week or the time of day and takes the pills found in that particular compartment.

However, these pillboxes pose the problem that the patient must carry them with him so as not to forget to take the pills. In the case of elderly patients who live alone, for example, this represents a significant problem, since even if they live relatively calm, orderly lives, it is easy for the patient to leave the pillbox somewhere and/or not have it when it comes time to take the medication. In addition, in environments that have a large number of elderly patients concentrated together, such as in retirement homes or geriatric hospitals, two patients may also swap their pillboxes by mistake, resulting in related problems.

It should also be pointed out that these pillboxes, in spite of being subdivided into “time” compartments (morning, afternoon and night), are not in and of themselves effective in helping the patient organize the times he needs to take the medication. In other words, the pillbox itself does not represent a mnemonic technique reminding the patient that he must take the pill, since the pillbox is not directly associated with any particular event during the day. This means that if the patient forgets to use the pillbox, he will also forget to take the pills.

### SUMMARY OF THE INVENTION

The objective of this invention is to overcome these difficulties. This purpose is achieved by means of a device that organizes the administration of pills into the type of predetermined time intervals that were mentioned earlier. It is characterized by the fact that it consists of a main body in the form of an individual napkin ring, with an opening capable of holding a napkin, and by having at least one compartment which may be closed by at least one lid, capable of holding at least one pill.

Most pills must be taken before or after breakfast, lunch or dinner. Therefore, due to the fact that the napkin ring includes a built-in pillbox, two simultaneous effects are achieved. On one hand, when the patient sits down at the table, he will always have the pillbox with him, which prevents him from forgetting to take the corresponding pill. In other words, the device itself serves as a mnemonic device, which helps the patient. When he picks up the napkin, he will automatically have the pillbox in his hand, which will help remind him that he must take the pills. This produces a subconscious association between the napkin and the time to take the medication. This represents a very important advantage over the current state-of-the-art pillboxes, especially when the patient is elderly. On the other hand, since the napkin ring is personal, in settings like retirement homes or geriatric hospitals, it also reduces the risk that two patients will swap their pillboxes. Before each meal, the caregiver fills each individual device assigned to a particular patient. As a result, the patient will always use his own device because he associates it with his own napkin.

Furthermore, the concept of a patient should not be interpreted too strictly with regards to this invention. A patient is a user who, in spite of leading a normal life, must take pills on a regular basis during the day. It does not necessarily imply that he is hospitalized or admitted to any sort of institution.

The device would ideally consist of three separate compartments that can be closed by at least one lid. This way, the compartments can be closed by a single lid; or for greater security, each compartment could have its own assigned lid. Each compartment corresponds to one of the main meals of the day: breakfast, lunch or dinner. Therefore, in the case of elderly persons who are assisted by someone in either a retirement home or a geriatric facility, the caregiver need only fill the devices once a day, which simplifies the organization of medication delivery. In the case of people who live alone, it also helps organize the daily administration, since the user only needs to organize the medication once a day.

Furthermore, the device would ideally include a modifiable, unequivocal means of representing the user's identification. This means of identifying the user might be, for example, a frame in which a photo, the patient's name or any other element could be inserted that unequivocally identifies him. This characteristic is especially useful in retirement homes and geriatric facilities. It helps the users identify their own devices and aids caregivers, as this information reduces the risk of placing one patient's pills in another patient's pillbox when preparing the devices.

Ideally, the means used to represent the patient would consist of a screen, and the device would also include an electronic system to control the screen. This would make it possible to display a digital photograph of the patient. The electronic system would make the device much more flexible, and it could be personalized in situ as the medication is being prepared. This means that, if so desired, the device could first be filled and then a photo uploaded of the patient who is supposed to take the medication. Additionally, the electronic system could provide on screen alarms if the patient fails to open the correct compartment after a certain period of time following the start of each meal.

The device would ideally include an opening system assigned to each lid, controlled electronically by the electronic control system and based on an alarm signal from a clock. This characteristic assists caregivers even further in controlling patients, since the device can be programmed to open and display a visual alarm (or even sound an auditory alarm) reminding the patient at the preset time. For example, the device could be programmed to open ten minutes before or after a meal begins, depending on whether the pills must be taken before eating or on a full stomach. This way, when the patient picks up his napkin, he will be informed that he must take the pill.

### BRIEF DESCRIPTION OF THE DRAWINGS

Other advantages and characteristics of this invention are included in the following description, which describes the optimal manner for manufacturing the invention (but by no means limiting it to this method) and refers to the illustrations provided. The figures show:

FIG. 1, a perspective view of the invention with a napkin inside.

FIG. 2, a perspective view of the invention with the lids that seal the pill compartment closed.

FIG. 3, a perspective view of the invention with the lids that seal the pill compartment open.

### DETAILED DESCRIPTION OF PREFERRED EMBODIMENTS

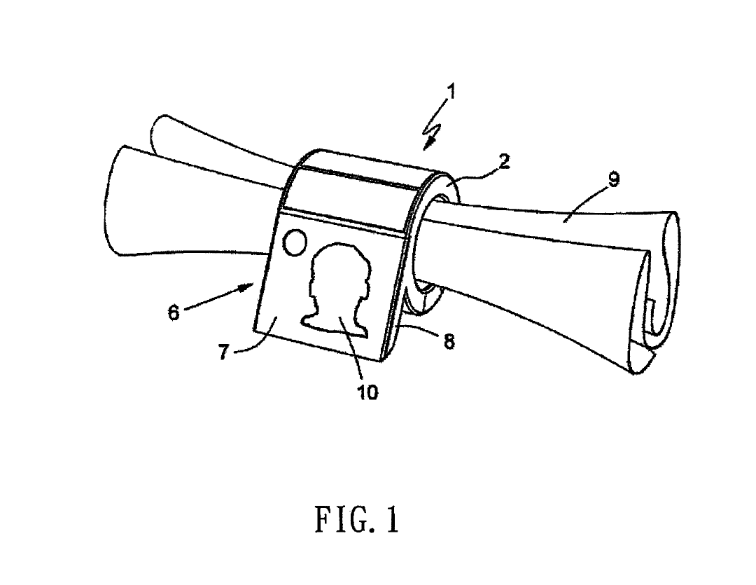

FIG. 1 shows how the device 1 consists of a cylindrical main body 2 with an opening 3 into which a napkin may be inserted 9. The main body 2 would ideally be equipped with an element of support 8 to ensure that the device 1 rests in a stable manner. It is not essential for purposes of this invention for the body 2 to be completely closed, nor for the main body 2 to be cylindrical. It is sufficient for the napkin to merely be securely held in place. It should also be mentioned that, for the purposes of this invention, it is irrelevant whether the napkin is made from cloth or a single-use material.

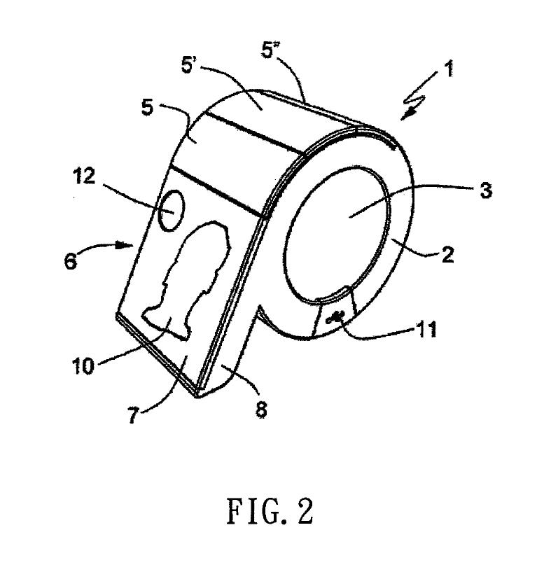

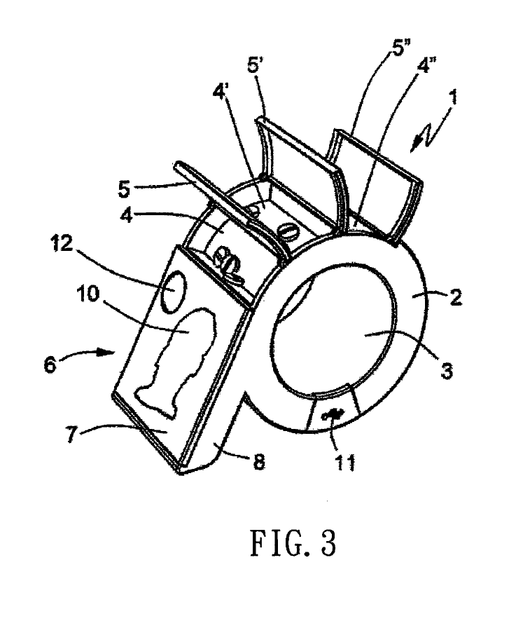

FIGS. 2 and 3 show that the top of the main body 2 is equipped with three separate 5, 5′, 5″ lids, each of which individually closes each compartment 4, 4′, 4″, which is capable of holding at least one pill. Alternatively, on a simpler version, the inner half of the main body 2 could be equipped with the same three compartments 4, 4′, 4″ and the outer half of the main body 2 could slide over the inner half along the longitudinal axis of the main body 2, serving as a lid for all three compartments.

Referring once again to the example shown in the figures, in this case, compartment 4 corresponds to breakfast, compartment 4′ corresponds to lunch, and finally, compartment 4″ corresponds to dinner. Therefore, to organize the timed administration of pills, the user of the device 1, whether a patient or a caregiver, need only be concerned with filling the device 1 in the morning before breakfast. When the patient sits down at the table, he will immediately associate the napkin 9 with the time to take the medication. This reduces the risk of forgetting to take a pill. The device 1 may also be optionally equipped with additional compartments for cases where the patient must take medication along with an afternoon snack.

In addition, the device 1 shown in the figures includes a means of representing the patient 6 in the form of a screen 7. The screen 7 is controlled electronically (not shown) and can be programmed, for example, through a USB-type input port 11 or any other standard input port to perform various functions. Alternatively, the device 1 may be programmed using a selection button 12 to avoid having to connect the device to a computer.

On the screen 7, it is possible to display a photograph 10 of the user that identifies him in an unequivocal manner. The screen 7 may also be used to display alphanumeric messages, such as the person's name, the time or reminders for the patient to take the medication corresponding to that particular time of day. Likewise, the screen 7 can display a visual alarm activated by the electronic system when an internal clock has been programmed accordingly. Optionally, the device 1 may include a means of providing a warning sound through a built-in speaker, which may also serve as an alarm.

An optimal version of the device 1 could be equipped with an opening system (not shown) assigned to each of the lids 5, 5′ 5″, which would control when they open. These opening systems could be as simple as an electronically-controlled inside latch and a spring that control the opening of the corresponding lid. In this manner, the device 1 can be set so that the lock releases the corresponding lid 5, 5′, 5″ at a certain time. It would open automatically as the result of the spring action. This further improves the safety while using the device 1, since the patient can only access those pills he should really take at any given time.

1. A device for organizing the administration of pills at predetermined time intervals, comprising a main body that serves as an individual napkin ring, with an opening to insert a napkin wherein the main body includes at least one compartment that is closed by at least one lid, capable of holding at least one said pill.

2. The device described in claim 1, further comprising three separate compartments that are closed by at least one lid.

3. The device described in claims 1, further comprising a means of representation, which is modifiable to unequivocally identify a user of the device.

4. The device described in claim 3, wherein the means of representation is a screen, and the device also includes an electronic system to control the screen.

5. The device described in claim 4, further comprising an opening system assigned to each of the lids, controlled by the electronic control system based on an alarm signal sent by a clock.
